(19) United States
(12) Patent Application Publication
(10) Pub. No.: US 2015/0073863 A1
(43) Pub. Date: Mar. 12, 2015

(54) Method and System for Linking Browsing History to Proprietary Transaction Data

(71) Applicant: MasterCard International Incorporated, Purchase, NY (US)

(72) Inventors: Nikhil MALGATTI, Stamford, CT (US); Serge BERNARD, Danbury, CT (US); Kenny UNSER, Fairfield, CT (US)

(73) Assignee: MasterCard International Incorporated, Purchase, NY (US)

(21) Appl. No.: 14/022,846

(22) Filed: Sep. 10, 2013

(51) Int. Cl. G06Q 30/02

(52) U.S. Cl. CPC G06Q 30/0201
USPC 705/7.29

(57) ABSTRACT

A method for linking browsing data to transaction history includes: storing, in a database, a plurality of consumer profiles, wherein each consumer profile includes data related to a consumer including at least a plurality of consumer demographic characteristics and a plurality of transaction data entries across a plurality of merchants, each transaction data entry corresponding to a payment transaction involving the related consumer; receiving, by a receiving device, browsing data, wherein the browsing data includes webpage browsing history and a plurality of browser-associated demographic characteristics; identifying, by a processing device, at least one consumer profile of the plurality of consumer profiles where at least a predefined number of the included plurality of consumer demographic characteristics correspond to the plurality of browser-associated demographic characteristics; and associating, in the database, each of the identified at least one consumer profile with the webpage browsing history included in the received browsing data.

### FIELD

The present disclosure relates to the linking of browsing data to transaction history, specifically the linking of consumer browsing history with consumer transaction history based on a plurality of demographic characteristics.

### BACKGROUND

Merchants, retailers, advertisers, and other entities try to collect as much pertinent information as they can about consumers. Having detailed information can enable these entities to target specific consumers or groups of consumers for the distribution of relevant offers, advertisements, etc. One method that many advertisers use for Internet advertising is to capture a consumer's browsing history. Advertisers may then identify advertisements and offers specific to the consumer based on their browsing history, which are then distributed or displayed to the consumer.

However, utilizing only a consumer's browsing history without additional information may provide for an inaccurate analysis of the consumer, which can further result in less effective advertising. For example, a consumer may view a number of merchant websites looking for a particular type of product, before finally settling on a merchant which to transact and a specific product to purchase. Without additional information, an advertiser or third party may be unable to identify which merchant the consumer preferred, or which product the consumer settled on. As such, the advertiser would also be unable to identify any reasoning behind the consumer's selection, which could provide the advertiser with valuable information about the consumer.

Thus, there is a need for a technical solution to capturing pertinent information regarding a consumer's preferences, in addition to browsing data.

### SUMMARY

The present disclosure provides a description of systems and methods for linking browsing data to transaction history and distributing consumer profiles.

A method for linking browsing data to transaction history includes: storing, in a database, a plurality of consumer profiles, wherein each consumer profile includes data related to a consumer including at least a plurality of consumer demographic characteristics and a plurality of transaction data entries across a plurality of merchants, each transaction data entry corresponding to a payment transaction involving the related consumer; receiving, by a receiving device, browsing data, wherein the browsing data includes webpage browsing history and a plurality of browser-associated demographic characteristics; identifying, by a processing device, at least one consumer profile of the plurality of consumer profiles where at least a predefined number of the included plurality of consumer demographic characteristics correspond to the plurality of browser-associated demographic characteristics; and associating, in the database, each of the identified at least one consumer profile with the webpage browsing history included in the received browsing data.

A method for distributing a linked consumer profile includes: storing, in a database, a plurality of consumer profiles, wherein each consumer profile includes data related to a consumer including at least a consumer identifier associated with the related consumer, a plurality of consumer demographic characteristics, and a plurality of transaction data entries across a plurality of merchants, each transaction data entry corresponding to a payment transaction involving the related consumer; receiving, by a receiving device, a consumer profile request, wherein the browsing data request includes at least a specific consumer identifier; identifying, in the database, a specific consumer profile where the included consumer identifier corresponds to the specific consumer identifier; transmitting, by a transmitting device, a request for browsing data, wherein the request for browsing data includes at least the plurality of consumer demographic characteristics included in the identified specific consumer profile; receiving, by the receiving device, webpage browsing history; including, in the database, the received webpage browsing history in the identified specific consumer profile; and transmitting, by the transmitting device, the specific consumer profile in response to the received browsing data request.

A system for linking browsing data to transaction history includes a database, a receiving device, and a processing device. The database is configured to store a plurality of consumer profiles, wherein each consumer profile includes data related to a consumer including at least a plurality of consumer demographic characteristics and a plurality of transaction data entries across a plurality of merchants, each transaction data entry corresponding to a payment transaction involving the related consumer. The receiving device is configured to receive browsing data, wherein the browsing data includes webpage browsing history and a plurality of browser-associated demographic characteristics. The processing device is configured to: identify at least one consumer profile of the plurality of consumer profiles where at least a predefined number of the included plurality of consumer demographic characteristics correspond to the plurality of browser-associated demographic characteristics; and associate, in the database, each of the identified at least one consumer profile with the webpage browsing history included in the received browsing data.

A system for distributing a linked consumer profile includes a database, a receiving device, a processing device, and a receiving device. The database is configured to store a plurality of consumer profiles, wherein each consumer profile includes data related to a consumer including at least a consumer identifier associated with the related consumer, a plurality of consumer demographic characteristics, and a plurality of transaction data entries across a plurality of merchants, each transaction data entry corresponding to a payment transaction involving the related consumer. The receiving device is configured to receive a consumer profile request, wherein the browsing data request includes at least a specific consumer identifier. The processing device is configured to identify, in the database, a specific consumer profile where the included consumer identifier corresponds to the specific consumer identifier. The transmitting device is configured to transmit a request for browsing data, wherein the request for browsing data includes at least the plurality of consumer demographic characteristics included in the identified specific consumer profile. The receiving device is further configured to receive webpage browsing history. The processing device is further configured to include, in the database, the received webpage browsing history in the identified specific consumer profile. The transmitting device is further configured to transmit the specific consumer profile in response to the received browsing data request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for linking consumer browsing data and transaction history in accordance with exemplary embodiments.

FIG. 2 is a block diagram illustrating the processing server of FIG. 1 for the linking of consumer browsing data and transaction history in accordance with exemplary embodiments.

FIG. 3 is a flow diagram illustrating a method for linking browsing data with transaction history in a consumer profile in accordance with exemplary embodiments.

FIG. 4 is a flow chart illustrating a method for populating and distributing a consumer profile including browsing data and transaction history in accordance with exemplary embodiments.

FIG. 5 is a diagram illustrating the linking of consumer browsing data to transaction history in accordance with exemplary embodiments.

FIG. 6 is a flow chart illustrating an exemplary method for linking browsing data to transaction history in accordance with exemplary embodiments.

FIG. 7 is a flow chart illustrating an exemplary method for distributing a linked consumer profile in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 108 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 108 may not possess the PII or be able to decrypt the encrypted PII.

### System for Linking Browsing Data to Transaction History

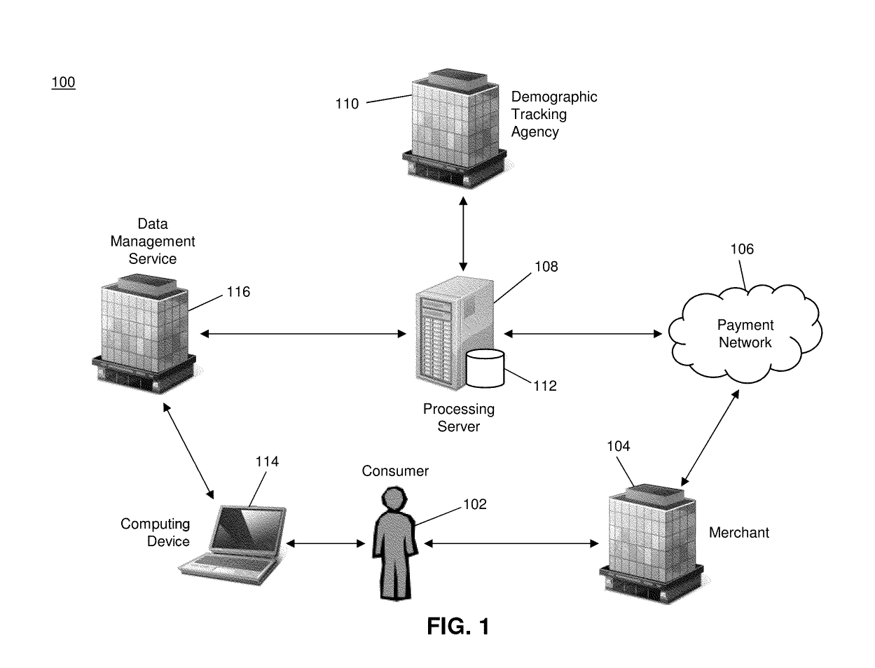

FIG. 1 illustrates a system 100 for linking consumer browsing data to consumer transaction history.

A consumer 102 may engage in one or more payment transactions at a merchant 104. The payment transaction or transactions may be conducted in person (e.g., at a physical location of the merchant 104), or remotely, such as via the Internet, telephone, by mail, etc. The transaction may be processed via a payment network 106. The payment network 106 may transmit a copy of the authorization request or transaction data included therein to a processing server 108, discussed in more detail below. The processing server 108 may store the transaction data in a consumer profile of a consumer database 112, also discussed in more detail below, wherein the profile is associated with the consumer 102. In an exemplary embodiment, the transaction data may only be stored in a consumer profile associated with the particular consumer 102 with the permission of the consumer 102.

The processing server 108 may receive demographic characteristics associated with the consumer 102 from a demographic tracking agency 110 or other third party. The demographic characteristics may include: age, gender, income, marital status, familial status, residential status, occupation, education, zip code, postal code, street address, county, city, state, country, etc. The processing server 108 may store the demographic characteristics in the consumer profile associated with the consumer 102. In an exemplary embodiment, the consumer profile associated with the consumer 102 may not include any personally identifiable information. In some instances, the consumer 102 may grouped with a plurality of consumers having similar or the same demographic characteristics.

The consumer 102 may have use a computing device 114 to browse the Internet via one or more browsing application programs. The computing device 114 may be any type of computing device suitable for browsing as will be apparent to persons having skill in the relevant art, such as a desktop computer, laptop computer, notebook computer, tablet computer, cellular phone, smart phone, etc. Browsing data for the consumer 102 may be obtained and stored by a data management service 116. In some instances, the computing device 114 may transmit browsing data to the data management service 116. In other instances, the data management service 116 may capture browsing data of the computing device 116. Methods and systems for capturing browsing data of a consumer will be apparent to persons having skill in the relevant art.

The data management service 116 may store historical browsing data, which may be browsing data over multiple sessions (e.g., multiple times of a single day, multiple days of a week, month, or year, etc.), associated with the consumer 102. The processing server 108 may request historical browsing data from the data management service 116. The data management service 116 may furnish the browsing data to the processing server 108, which it may then store in corresponding consumer profiles in the consumer database 112.

In some embodiments, the data management service 116 may provide browsing data to the processing server 108 associated with browser-associated demographic characteristics. In such an embodiment, the processing server 108 may match the browsing data to one or more consumer profiles based on the browser-associated demographic characteristics and the demographic characteristics of the one or more consumer profiles. In other embodiments, the processing server 108 may transmit demographic characteristics for one or more consumer profiles to the data management service 116. The data management service 116 may identify browsing data corresponding to the demographic characteristics, and distribute the browsing data to the processing server 108. The processing server 108 may then store the browsing data in the corresponding one or more consumer profiles. Additional methods for obtaining the browsing data for one or more consumers without personally identifying a consumer will be apparent to persons having skill in the relevant art.

The processing server 108 may then have transaction history and browsing data for a consumer 102 linked together in a consumer profile associated with the consumer 102. In an exemplary embodiment, the consumer profile may not include any personally identifiable information for the consumer 102, except with the express consent of the consumer 102. By linking transaction history with browsing data, the processing server 108, or a third party, such as an advertiser, that may receive the data from the processing server 108, may be able to obtain significantly more data from a consumer's browsing history than utilizing browsing history alone. Furthermore, the transaction history may also include activity not conducted via the computing device 114 (e.g., an in-person transaction involving the consumer 102 and the merchant 104), and thus may provide significantly additional, and valuable, information in addition to the browsing data.

### Processing Device

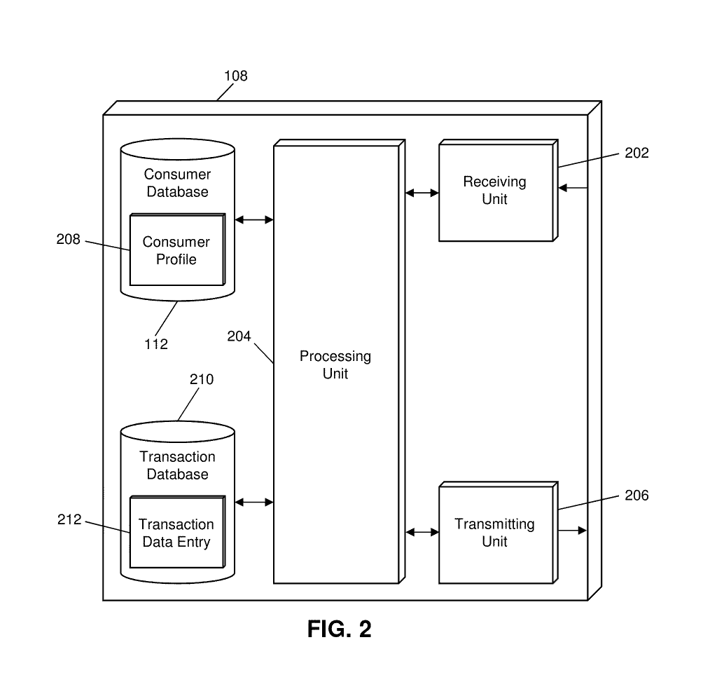

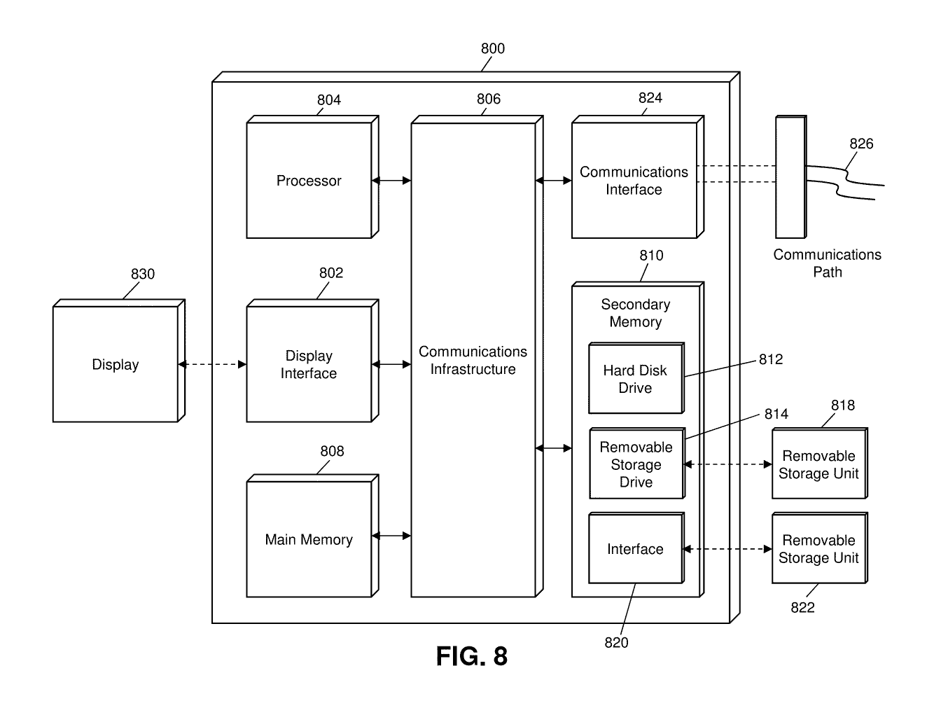

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include a receiving unit 202. The receiving unit 202 may be configured to receive data over one or more networks via one or more network protocols. The receiving unit 202 may be configured to receive transaction data, demographic characteristic data, and browsing data.

The processing server 108 may also include a processing unit 204. The processing unit 204 may be configured to store received transaction data in a transaction database 210 as one or more transaction data entries 212. Each transaction data entry 212 may include data related to a corresponding payment transaction, such as a consumer identifier, merchant identifier, transaction amount, transaction time and/or date, geographic location, merchant name, product data, coupon or offer data, a point-of-sale identifier, or other suitable information as will be apparent to persons having skill in the relevant art. In some embodiment, each transaction data entry may also include demographic characteristics for a consumer involved in the corresponding payment transaction.

The processing unit 204 may also be configured to store a plurality of consumer profiles 208 in the consumer database 112. Each consumer profile 208 may include data related to a consumer (e.g., the consumer 102), including at least a plurality of consumer demographic characteristics. In some embodiments, each consumer profile 208 may also include a plurality of transaction data entries 212. The plurality of transaction data entries 212 included in each consumer profile 208 may be identified via a consumer identifier (e.g., an identification number, a payment account number, etc.) or other information suitable for identifying the consumer profile 208. In an exemplary embodiment, each consumer profile 208 may not include personally identifiable information unless the corresponding consumer 102 expressly consents. In such an embodiment, the consumer identifier may be related to a particular consumer, without being personally identifiable to the consumer, such as a payment account number encrypted via one-way encryption. In some embodiments, each consumer profile 208 may be associated with a specific set of demographic characteristics and may accordingly be related to a generic consumer of those demographic characteristics rather than an actual consumer 102.

The processing unit 204 may be configured to link consumer profiles 208 with transaction data entries 212 based on demographic characteristics. The processing unit 204 may also be configured to link consumer profiles 208 including transaction data entries 212 with browsing data received by the receiving unit 202. The processing unit 204 may be configured to link the consumer profiles 208 with the browsing data via demographic characteristics included in the consumer profiles 208 and in the received browsing data. In some instances, the processing unit 204 may match browsing data to transaction history based on a predefined number of demographic characteristics (e.g., at least the predefined number of characteristics must match). In other instances, transaction history and browsing data may be matched via algorithms or other systems and methods that will be apparent to persons having skill in the relevant art. In some embodiments, the processing unit 204 may store the received browsing data in the linked consumer profile 208.

The processing server 108 may also include a transmitting unit 206. The transmitting unit 206 may be configured to transmit data over one or more networks via one or more network protocols. The transmitting unit 206 may be configured to transmit requests for data, such as to the demographic tracking agency 110 and/or the data management service 116. The transmitting unit 206 may also be configured to transmit transaction history and/or browsing data, or a consumer profile 208 including linked transaction history and browsing data, in response to a request from a third party (e.g., an advertiser).

### Method for Linking Browsing Data to Transaction History

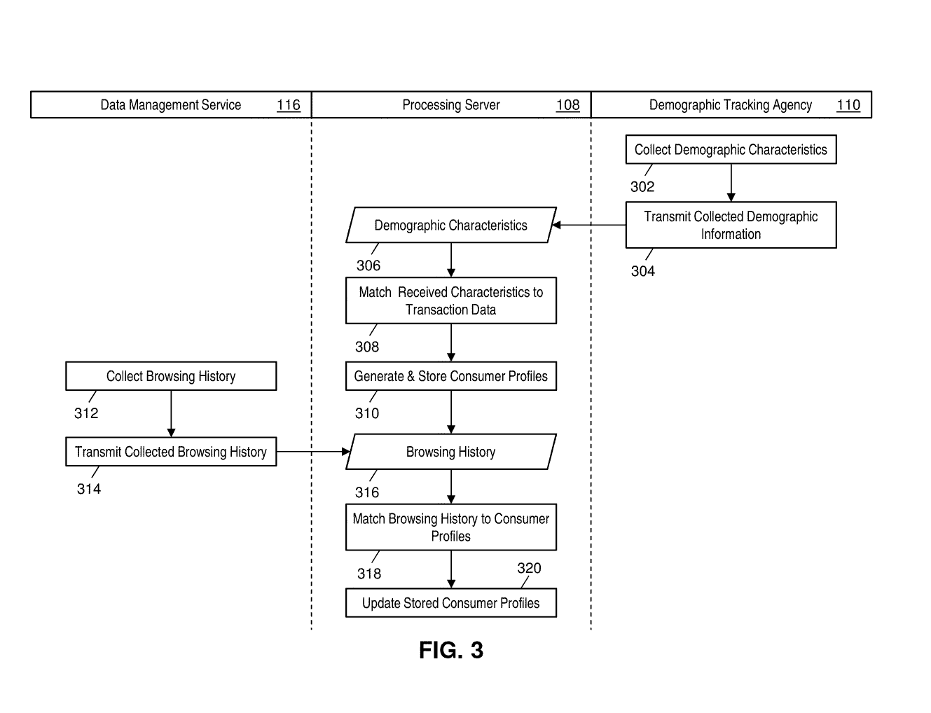

FIG. 3 illustrates a method for linking consumer browsing data to transaction history.

In step 302, the demographic tracking agency 110 may collect demographic characteristics for one or more consumers. Methods and systems for collecting demographic characteristics will be apparent to persons having skill in the relevant art. The demographic tracking agency 110 may collect the information and may, in step 304, transmit the collected demographic characteristic information to the processing server 108.

In step 306, the processing server 108 may receive the demographic characteristic information. In step 308, the processing unit 204 of the processing server 108 may match the received demographic characteristic information to transaction data entries 212 included in the transaction database 210. In step 310, the processing unit 204 may generate consumer profiles 208 for matched transaction history and demographic characteristics and store the consumer profiles 208 in the consumer database 112. In an exemplary embodiment, the processing unit 204 may bucket or otherwise modify the demographic characteristic information and/or transaction data to render the corresponding consumer profile 208 not personally identifiable. In some instances, the processing unit 204 may group transaction data entries 212 for multiple consumers sharing demographic characteristics into a single consumer profile 208.

In step 312, the data management service 116 may collect browsing history for one or more consumers 102, the browsing history including webpage browsing history and a plurality of browser-associated demographic characteristics that are associated with the corresponding one or more consumers 102. In some embodiments, the data management service 116 may collect historical browsing data over an extended period of time. In step 314, the data management service 116 may transmit the collected browsing history to the processing server 108. The processing server 108 may, in step 316, receive the browsing history from the data management service 116.

In step 318, the processing unit 204 of the processing server 108 may match the received browsing history to the consumer profiles 208 based on matching of the demographic characteristics. In step 320, the processing unit 204 may update the consumer profiles 208 to include and/or be associated with the matched browsing history.

### Method for Distributing a Consumer Profile

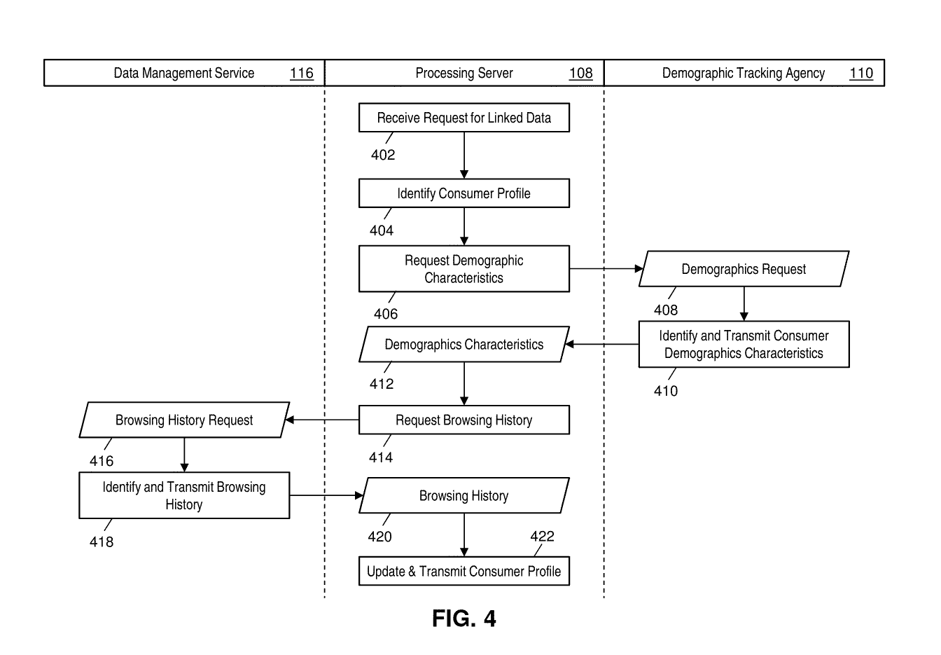

FIG. 4 illustrates a method for distributing a consumer profile including linked browsing data and transaction history.

In step 402, the processing server 108 may receive (e.g., via the receiving unit 202) a request for linked consumer browsing and transaction data. The request for linked data may include a consumer identifier or other identifying information, such as demographic characteristics. In step 404, the processing unit 204 may identify, in the consumer database 112, a consumer profile 208 based on the information included in the request.

In step 406, the processing server 108 may transmit (e.g., via the transmitting unit 206), a request for demographic characteristics for the consumer associated with the identified consumer profile 208. In step 408, the demographic tracking agency 110 may receive the request, and, in step 410, may identify demographic characteristics associated with the consumer and transmit them back to the processing server 108. In step 412, the processing server 108 may receive the demographic characteristics associated with the consumer 102 related to the identified consumer profile 208.

In step 414, the processing server 108 may request browsing history for the consumer 102 from the data management service 116. The browsing history request may include the previously received demographic characteristics. In step 416, the data management service 116 may receive the browsing history request, and, in step 418, identify browsing history associated with the demographic characteristics received in the browsing history request. The data management service 116 may transmit the browsing history to the processing server 108, which may receive the browsing data in step 420.

In step 422, the processing server 108 may update the consumer profile 208 to include the received browsing data, and may transmit the consumer profile 208 and/or the included transaction history and browsing data as a response to the initially received request. In an exemplary embodiment, the consumer profile 208 may not include any personally identifiable information for the related consumer 102. In other embodiments, the processing server 108 may remove and/or render personally unidentifiable any personally identifiable information included in the consumer profile 208.

### Linking Browsing Data to Transaction History

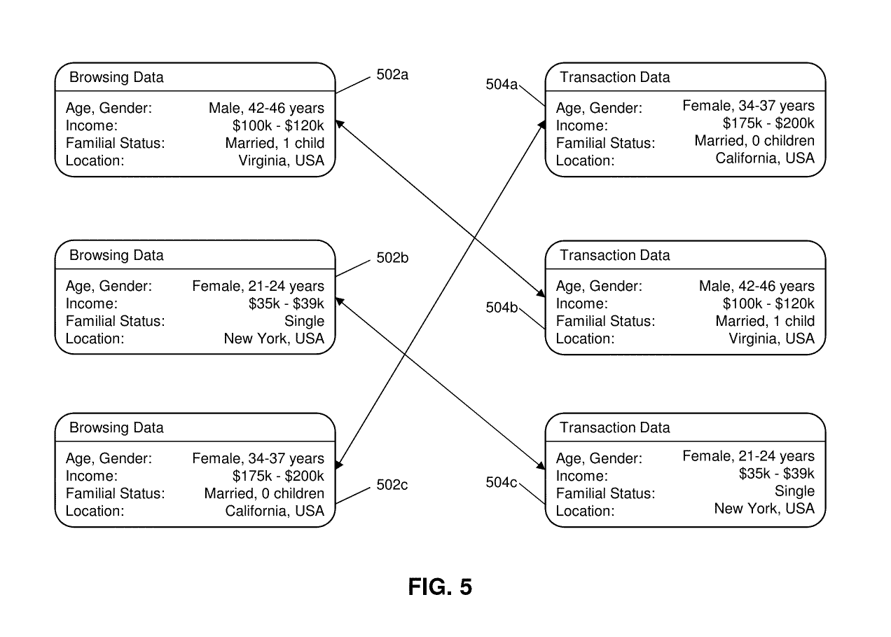

FIG. 5 illustrates the linking of consumer browsing data 502 to transaction history 504 using demographic characteristics.

Each set of browsing data 502, illustrated in FIG. 5 as browsing data 502a, 502b, and 502c, may correspond to a consumer 102 and include a plurality of demographic characteristics. For example, browsing data 502a corresponds to a consumer 102 that is a male, of an age between 42 and 46 years old, has an income between $100,000 and $120,000, is married, has one child, and lives in Virginia. In some embodiments, the browsing data 502a may correspond to a plurality of consumers each having the same demographic characteristics data.

Each set of transaction data 504, illustrated in FIG. 5 as transaction data 504a, 504b, and 504c, may correspond to a consumer 102 or a plurality of consumers 102, and include a plurality of demographic characteristics associated with the corresponding consumer or consumers 102. For example, transaction data 504a may correspond to a consumer 102 that is a female, of an age between 34 and 37 years old, has an income between $175,000 and $200,000, is married, has no children, and lives in California.

The processing unit 204 of the processing server 108 may identify the demographic characteristics for each of the browsing data 502 and transaction data 504 and match the two sets of data based on common demographic characteristics. For example, in the example illustrated in FIG. 5, the processing unit 204 may match browsing data 502a with transaction data 504b, browsing data 502b with transaction data 504c, and browsing data 502c with transaction data 504a. The processing unit 204 may then store the linked data in one or more consumer profiles 208 including the corresponding demographic characteristics.

In some embodiments, the demographic characteristics for the browsing data 502 may not directly correspond to the demographic characteristics for the transaction data 504. In such an instance, the processing unit 204 may be configured to link the data based on a predefined number of matching characteristics. For example, if the transaction data 504b was associated with a consumer 102 having two children, while the browsing data 502a is associated with a consumer 102 having only one child, the processing unit 204 may still link the two sets of data because the sets have at least five matching demographic characteristics including age, gender, income, marital status, and geographic location.

### Exemplary Method for Linking Browsing Data to Transaction History

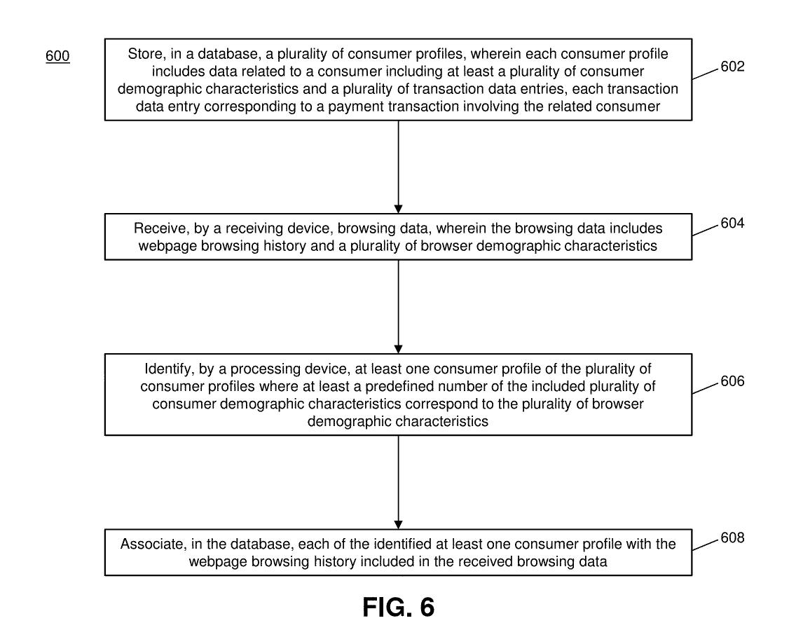

FIG. 6 illustrates a method 600 for linking consumer browsing data to transaction history using demographic characteristics.

In step 602, a plurality of consumer profiles (e.g., the consumer profiles 208) may be stored in a database (e.g., the consumer database 112), wherein each consumer profile 208 includes data related to a consumer (e.g., the consumer 102) including at least a plurality of consumer demographic characteristics and a plurality of transaction data entries (e.g., transaction data entries 212), each transaction data entry 212 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 604, browsing data may be received, by a receiving device (e.g., the receiving unit 202), wherein the browsing data includes webpage browsing history and a plurality of browser demographic characteristics. In step 606, at least one consumer profile 208 of the plurality of consumer profiles may be identified, by a processing device (e.g., the processing unit 204), where at least a predefined number of the included plurality of consumer demographic characteristics correspond to the plurality of browser demographic characteristics. In step 608, each of the identified at least one consumer profiles 208 may be associated, in the database 112, with the webpage browsing history included in the received browsing data.

### Exemplary Method for Distributing a Linked Consumer Profile

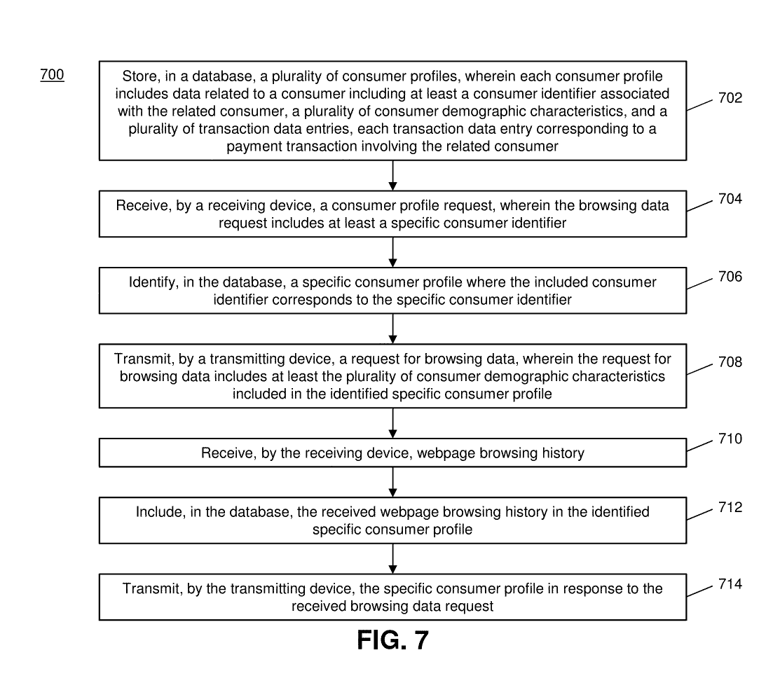

FIG. 7 illustrates a method 700 for distributing a consumer profile including browsing data and transaction history linked based on demographic characteristics.

In step 702, a plurality of consumer profiles (e.g., the consumer profiles 208) may be stored, in a database (e.g., the consumer database 112), wherein each consumer profile 208 includes data related to a consumer (e.g., the consumer 102), including at least a consumer identifier associated with the related consumer 102, a plurality of consumer demographic characteristics, and a plurality of transaction data entries (e.g., transaction data entries 212), each transaction data entry 212 corresponding to a payment transaction involving the related consumer 102. In some embodiments, the plurality of demographic characteristics may not be personally identifiable.

In one embodiment, the plurality of consumer demographic characteristics may include at least one of: age, gender, income, marital status, familial status, residential status, occupation, education, zip code, postal code, street address, county, city, state, and country. In some embodiments, each transaction data entry 212 may include at least transaction data, a consumer identifier associated with the related consumer 102, and a merchant identifier associated with a merchant (e.g., the merchant 104) involved in the corresponding payment transaction. In a further embodiment, the transaction data may include at least one of: a transaction amount, product data, transaction time and/or date, geographic location, coupon data, and point-of-sale identifier.

In step 704, a consumer profile request may be received, by a receiving device (e.g., the receiving unit 202), wherein the browsing data request includes at least a specific consumer identifier. In step 706, a specific consumer profile 208 may be identified, in the database 112, where the included consumer identifier corresponds to the specific consumer identifier. In step 708, a request for browsing data may be transmitted, by a transmitting device (e.g., the transmitting unit 206), wherein the request for browsing data includes at least the plurality of consumer demographic characteristics included in the identified specific consumer profile 208.

In step 710, the receiving device 202 may receive webpage browsing history. In one embodiment, the request for browsing data may further include a predefined number, the received webpage browsing history may be associated with browser-associated demographic characteristics, and a number of the plurality of consumer demographic characteristics included in the specific consumer profile 208 that correspond to the plurality of browser-associated demographic characteristics is at least the predefined number. In step 712, the received webpage browsing history may be included, in the database 11, in the identified specific consumer profile 208. In step 714, the specific consumer profile 208 may be transmitted, by the transmitting device 206, in response to the received browsing data request.

### Computer System Architecture

FIG. 8 illustrates a computer system 800 in which embodiments of the present disclosure, or portions thereof, may be implemented as computer-readable code. For example, the processing server 108 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3, 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for providing characteristic payments data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for linking browsing data to transaction history, comprising:
storing, in a database, a plurality of consumer profiles, wherein each consumer profile includes data related to a consumer including at least a plurality of consumer demographic characteristics and a plurality of transaction data entries across a plurality of merchants, each transaction data entry corresponding to a payment transaction involving the related consumer;
receiving, by a receiving device, browsing data, wherein the browsing data includes webpage browsing history and a plurality of browser-associated demographic characteristics;
identifying, by a processing device, at least one consumer profile of the plurality of consumer profiles where at least a predefined number of the included plurality of consumer demographic characteristics correspond to the plurality of browser-associated demographic characteristics; and
associating, in the database, each of the identified at least one consumer profile with the webpage browsing history included in the received browsing data.

2. The method of claim 1, wherein the plurality of consumer demographic characteristics includes at least one of: age, gender, income, marital status, familial status, residential status, occupation, education, zip code, postal code, street address, county, city, state, and country.

3. The method of claim 1, wherein each transaction data entry includes at least transaction data, a consumer identifier associated with the related consumer, and a merchant identifier associated with a merchant involved in the corresponding payment transaction.

4. The method of claim 3, wherein the transaction data includes at least one of: a transaction amount, product data, transaction time and/or date, geographic location, coupon data, and point-of-sale identifier.

5. The method of claim 1, wherein the plurality of demographic characteristics are not personally identifiable.

6. A method for distributing a linked consumer profile, comprising:
storing, in a database, a plurality of consumer profiles, wherein each consumer profile includes data related to a consumer including at least a consumer identifier associated with the related consumer, a plurality of consumer demographic characteristics, and a plurality of transaction data entries across a plurality of merchants, each transaction data entry corresponding to a payment transaction involving the related consumer;
receiving, by a receiving device, a consumer profile request, wherein the browsing data request includes at least a specific consumer identifier;
identifying, in the database, a specific consumer profile where the included consumer identifier corresponds to the specific consumer identifier;
transmitting, by a transmitting device, a request for browsing data, wherein the request for browsing data includes at least the plurality of consumer demographic characteristics included in the identified specific consumer profile;
receiving, by the receiving device, webpage browsing history;
including, in the database, the received webpage browsing history in the identified specific consumer profile; and
transmitting, by the transmitting device, the specific consumer profile in response to the received browsing data request.

7. The method of claim 6, wherein
the request for browsing data further includes a predefined number,
the webpage browsing history is associated with browser-associated demographic characteristics, and
a number of the plurality of consumer demographic characteristics included in the specific consumer profile that correspond to the plurality of browser-associated demographic characteristics is at least the predefined number.

8. The method of claim 6, wherein the plurality of consumer demographic characteristics includes at least one of: age, gender, income, marital status, familial status, residential status, occupation, education, zip code, postal code, street address, county, city, state, and country.

9. The method of claim 6, wherein each transaction data entry includes at least transaction data, a consumer identifier associated with the related consumer, and a merchant identifier associated with a merchant involved in the corresponding payment transaction.

10. The method of claim 9, wherein the transaction data includes at least one of: a transaction amount, product data, transaction time and/or date, geographic location, coupon data, and point-of-sale identifier.

11. The method of claim 6, wherein the plurality of demographic characteristics are not personally identifiable.

12. A system for linking browsing data to transaction history, comprising:
a database configured to store a plurality of consumer profiles, wherein each consumer profile includes data related to a consumer including at least a plurality of consumer demographic characteristics and a plurality of transaction data entries across a plurality of merchants, each transaction data entry corresponding to a payment transaction involving the related consumer;
a receiving device configured to receive browsing data, wherein the browsing data includes webpage browsing history and a plurality of browser-associated demographic characteristics; and
a processing device configured to
identify at least one consumer profile of the plurality of consumer profiles where at least a predefined number of the included plurality of consumer demographic characteristics correspond to the plurality of browser-associated demographic characteristics, and
associate, in the database, each of the identified at least one consumer profile with the webpage browsing history included in the received browsing data.

13. The system of claim 12, wherein the plurality of consumer demographic characteristics includes at least one of: age, gender, income, marital status, familial status, residential status, occupation, education, zip code, postal code, street address, county, city, state, and country.

14. The system of claim 12, wherein each transaction data entry includes at least transaction data, a consumer identifier associated with the related consumer, and a merchant identifier associated with a merchant involved in the corresponding payment transaction.

15. The system of claim 14, wherein the transaction data includes at least one of: a transaction amount, product data, transaction time and/or date, geographic location, coupon data, and point-of-sale identifier.

16. The system of claim 12, wherein the plurality of demographic characteristics are not personally identifiable.

17. A system for distributing a linked consumer profile, comprising:
a database configured to store a plurality of consumer profiles, wherein each consumer profile includes data related to a consumer including at least a consumer identifier associated with the related consumer, a plurality of consumer demographic characteristics, and a plurality of transaction data entries across a plurality of merchants, each transaction data entry corresponding to a payment transaction involving the related consumer;
a receiving device configured to receive a consumer profile request, wherein the browsing data request includes at least a specific consumer identifier;
a processing device configured to identify, in the database, a specific consumer profile where the included consumer identifier corresponds to the specific consumer identifier; and
a transmitting device configured to transmit a request for browsing data, wherein the request for browsing data includes at least the plurality of consumer demographic characteristics included in the identified specific consumer profile, wherein
the receiving device is further configured to receive webpage browsing history,
the processing device is further configured to include, in the database, the received webpage browsing history in the identified specific consumer profile, and
the transmitting device is further configured to transmit the specific consumer profile in response to the received browsing data request.

18. The system of claim 17, wherein the request for browsing data further includes a predefined number, the webpage browsing history is associated with browser demographic characteristics, and at least the predefined number of the plurality of consumer demographic characteristics included in the specific consumer profile correspond to the plurality of browser demographic characteristics.

19. The system of claim 17, wherein the plurality of consumer demographic characteristics includes at least one of: age, gender, income, marital status, familial status, residential status, occupation, education, zip code, postal code, street address, county, city, state, and country.

20. The system of claim 17, wherein each transaction data entry includes at least transaction data, a consumer identifier associated with the related consumer, and a merchant identifier associated with a merchant involved in the corresponding payment transaction.

21. The system of claim 20, wherein the transaction data includes at least one of: a transaction amount, product data, transaction time and/or date, geographic location, coupon data, and point-of-sale identifier.

22. The system of claim 17, wherein the plurality of demographic characteristics are not personally identifiable.
